(19) United States
(12) Patent Application Publication
(10) Pub. No.: US 2026/0017172 A1
(43) Pub. Date: Jan. 15, 2026

(54) PREDICTING COMPUTER CODE UPDATE CONDITIONS USING ARTIFICIAL INTELLIGENCE

(71) Applicant: Capital One Services, LLC, McLean, VA (US)

(72) Inventors: Samuel SHARPE, Cambridge, MA (US); Brian BARR, Schenectady, NY (US); Taylor TURNER, Richmond, VA (US); Jeremy GOODSITT, Champaign, IL (US)

(73) Assignee: Capital One Services, LLC, McLean, VA (US)

(21) Appl. No.: 18/769,383

(22) Filed: Jul. 10, 2024

(51) Int. Cl. G06F 11/36

(52) U.S. Cl. CPC G06F 11/3624

(57) ABSTRACT

Methods and systems are described herein for building and executing an artificial intelligence model that predicts whether a computer code update is likely to cause an issue. In particular, the system may receive a potential code update and identify update parameters associated with the potential code update. The system may then input the potential code update and the update parameters into a machine learning model to receive a prediction about the potential code update to be displayed to a user.

### BACKGROUND

In recent years, the amount of computer code that has been written and updated has increased exponentially. Maintaining computer code and updates to that computer code has become more difficult. Accordingly, as computer code is updated, it is possible that he updates may cause failures or other issues. Accordingly, a mechanism is needed for determining whether computer code updates are likely to cause issues in other parts of the code.

### SUMMARY

Therefore, methods and systems are described herein for building an artificial intelligence model that predicts whether a computer code update is likely to cause an issue. A code analysis system may be used to perform operations disclosed herein. The code analysis system may receive updated computer code. The updated computer code may include a computer code update to computer code within a computer code repository. For example, a developer may desire to update a function or a procedure within a computer code repository. Prior to the update being deployed, the updated computer code may be analyzed to predict whether the computer code may cause issues when updated. Accordingly, the computer code to be updated may be sent to the analysis system for analysis.

When the updated computer code is received, the analysis system may determine which portion, within the computer code repository, is being updated. In particular, the code analysis system may identify, within the computer code repository, a segment of a plurality of segments corresponding to the updated computer code. The computer code within the computer code repository may have been split into the plurality of segments based on a plurality of computer code portions that have been updated during a predetermined time period. For example, the computer code may be split into functions or procedures or other suitable portions. In some embodiments, the split may be based on prior updates to the computer code. For example, if a particular set of procedures or functions has been previously updated, that set may be split into one or more portions.

The analysis system may then determine the differences between the original code and the proposed code update. In particular, the analysis system may generate, based on the updated computer code, segment data such that the segment data may include one or more code update parameters. The code parameters may include variable update parameters, commit parameters, or lines of code parameters. For example, variable update parameters may include the difference in a number and/or type of variables between the original code segment and the proposed code segment.

The analysis system may then use a machine learning model for predicting whether the proposed code update is likely to cause issues. In particular, the analysis system may input, into a machine learning model, the segment data to obtain a condition associated with the updated computer code. The machine learning model may be one that has been trained using time series data generated based on code updates to a plurality of portions of the computer code. For example, the machine learning model may output a Boolean or another suitable output that indicates whether the proposed code update is predicted to cause an issue. In some embodiments, the machine learning model may output an action identifier for a condition to be remediated so that the proposed code update does not cause any issues.

The analysis system may then determine, based on the condition identifier, an action to be performed on the code to remediate the code. In particular, the analysis system may, based on the condition received from the machine learning model, generate one or more action identifiers for a user to perform. The action identifiers may then be generated for display for the user. For example, if the code is predicted to have an unsupported or an incompatible variable, the analysis system may display an action requiring a removal of that variable.

In some embodiments, the analysis system may use predetermined conditions to recommend actions to the user. For example, the analysis system may compare the condition with a plurality of predetermined conditions and identify functions that are associated with any matching predetermined conditions. Those functions may then be recommended to a user.

The machine learning model for predicting whether the proposed code update may cause issues may be trained prior to use. In particular, a training system may use the code that was previously used for updates with labels describing any issues the code caused or did not cause. Thus, the analysis system may receive computer code update data. The computer code update data may include a plurality of computer code segments that were used as updates to a computer code repository over a period of time. That is, the computer code data may include previous computer code updates and labeling data indicating whether the update caused any issues and one or more categories of issues.

The training system may then split the computer code within the computer code repository into a plurality of portions based on the plurality of computer code segments within the computer code update data. Each portion may correspond to a segment of the computer code. For example, the training system may split the code according to functions and procedures that have been previously updated and use those portions in the training.

The training system may then identify segment data for each portion (e.g., variable update parameters, commit parameters, or lines of code parameters). In particular, the training system may determine, for each portion of the plurality of portions based on a corresponding segment, corresponding segment data. Each segment data may include one or more code update parameters, the one or more code update parameters including variable update parameters, commit parameters, or lines of code parameters.

The training system may then generate a training dataset for training the machine learning model. In particular the training system may generate, for the plurality of portions, a time series dataset that includes combined segment data arranged chronologically. The training system may then train a machine learning model using the time series dataset and the plurality of portions of code to output a condition associated with a candidate code portion when the candidate code portion is input into the machine learning model. That is, the machine learning model may be trained to output an indication of whether the computer code is predicted to cause issues and a type or category of issue.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for building and executing an artificial intelligence model that predicts issues with updated computer code, in accordance with one or more embodiments of this disclosure.

FIG. 2 illustrates an excerpt of a data structure storing segment data, in accordance with one or more embodiments of this disclosure.

FIG. 3 illustrates an excerpt of a data structure storing update parameters, in accordance with one or more embodiments of this disclosure.

FIG. 4 illustrates an exemplary machine learning model, in accordance with one or more embodiments of this disclosure.

FIG. 5 illustrates a display screen, in accordance with one or more embodiments of this disclosure.

FIG. 6 illustrates a computing device, in accordance with one or more embodiments of this disclosure.

FIG. 7 is a flowchart of operations for executing an artificial intelligence model that predicts issues with updated computer code, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

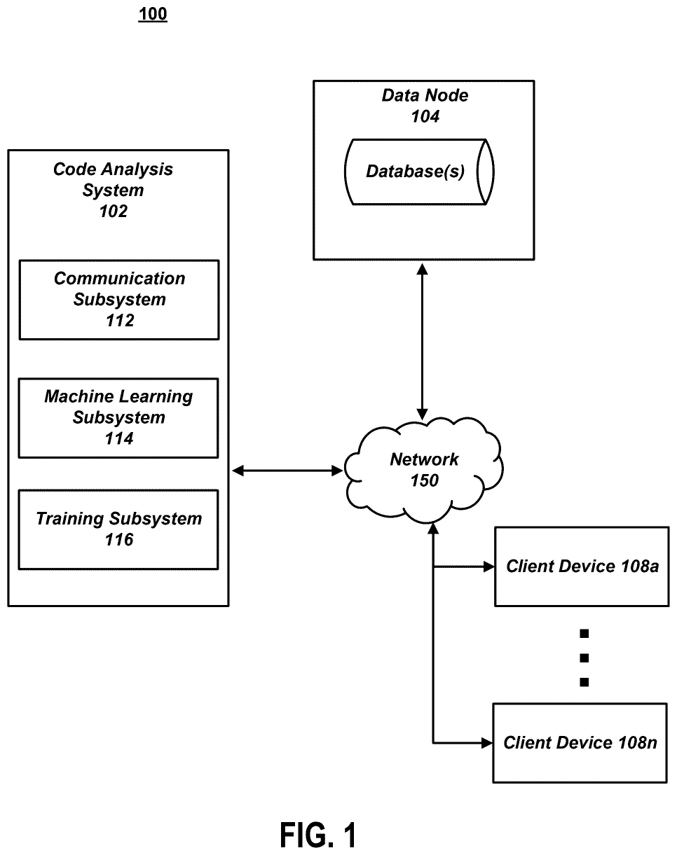

FIG. 1 is an example of environment 100 for building and executing an artificial intelligence model that predicts issues with updated computer code. Environment 100 includes code analysis system 102, data node 104, and client devices 108a-108n. Code analysis system 102 may execute instructions for building and executing an artificial intelligence model that predicts issues with updated computer code. Code analysis system 102 may include software, hardware, or a combination of the two. For example, code analysis system 102 may be a physical server or a virtual server that is running on a physical computer system. In some embodiments, code analysis system 102 may be configured on a user device (e.g., a laptop computer, a smartphone, a desktop computer, an electronic tablet, or another suitable user device).

Data node 104 may store various data, including one or more machine learning models, training data, code segments, computer code repository, and/or other suitable data. In some embodiments, data node 104 may also be used to train the machine learning model. Data node 104 may include software, hardware, or a combination of the two. For example, data node 104 may be a physical server, or a virtual server that is running on a physical computer system. In some embodiments, code analysis system 102 and data node 104 may reside on the same hardware and/or the same virtual server/computing device. Network 150 may be a local area network, a wide area network (e.g., the internet), or a combination of the two. Client devices 108a-108n may be end-user computing devices (e.g., desktop computers, laptops, electronic tablets, smart phones, and/or other computing devices used by end users).

Code analysis system 102 may receive updated computer code. The updated computer code may include a computer code update to computer code within a computer code repository. Code analysis system 102 may receive the updated computer code using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive the updated computer code from data node 104 or from another computing device. In some embodiments, communication subsystem 112 may receive the updated computer code from one or more client devices 108a-108n.

In some embodiments, the computer code being used for various applications may reside in a computer code repository which may be a central database that stores computer code. The computer code repository may store functions, procedures, application programming interfaces, and other types of computer code. The computer code may be retrieved from the computer code repository to be used or may be executed using an application programming interface (API). The updated computer code may be computer code that is to replace some current computer code within the computer code repository. Communication subsystem 112 may pass the updated computer code, or a pointer to the updated computer code in memory, to machine learning subsystem 114.

Machine learning subsystem 114 may include software components, hardware components, or a combination of both. For example, machine learning subsystem 114 may include software components (e.g., API calls) that access one or more machine learning models. Machine learning subsystem 114 may access various data, for example, in memory. Machine learning subsystem 114 may then determine which portion of the computer code is to be updated. In particular machine learning subsystem 114 may identify, within the computer code repository, a segment of a plurality of segments corresponding to the updated computer code. The computer code within the computer code repository may have been split into the plurality of segments based on a plurality of computer code portions that have been updated during a predetermined time period. For example, machine learning subsystem 114 may determine that certain APIs, procedures, functions, and/or other portions of the computer code in the computer code repository have been updated over time. Accordingly, machine learning subsystem 114 may split the computer code within the computer code repository based on the portions or segments that have been updated.

In some embodiments, machine learning subsystem 114 may perform the following operations to identify the segment being updated. Machine learning subsystem 114 may compare execution commands for each code segment of the plurality of segments with corresponding execution commands for the updated computer code, and determine, based on comparing, that a first code segment of the plurality of segments matches the updated computer code. For example, the update may be an update to a particular function that may be called with a particular set of variables and variable types. Accordingly, machine learning subsystem 114 may iterate through each function within the computer code repository and identify the function that is being updated. In some embodiments, the updated computer code itself may include a pointer to the correct segment that is being updated.

In some embodiments, machine learning subsystem 114 may split the computer code using the following operations: identifying, for each segment of a plurality of computer code segments, a corresponding portion within the computer code repository. For example, machine learning subsystem 114 may access a dataset that stores a plurality of older segments that have been updated over time. Some older segments may correspond to the same current segment (e.g., the current segment was a result of multiple updates to the code segment within the repository), while other segments may correspond to only one current segment. Machine learning subsystem 114 may compare all the older segments to try and match those to a particular current segment. Segment matching is described below in this disclosure (e.g., via a similarity model and/or via comparing segment parameters).

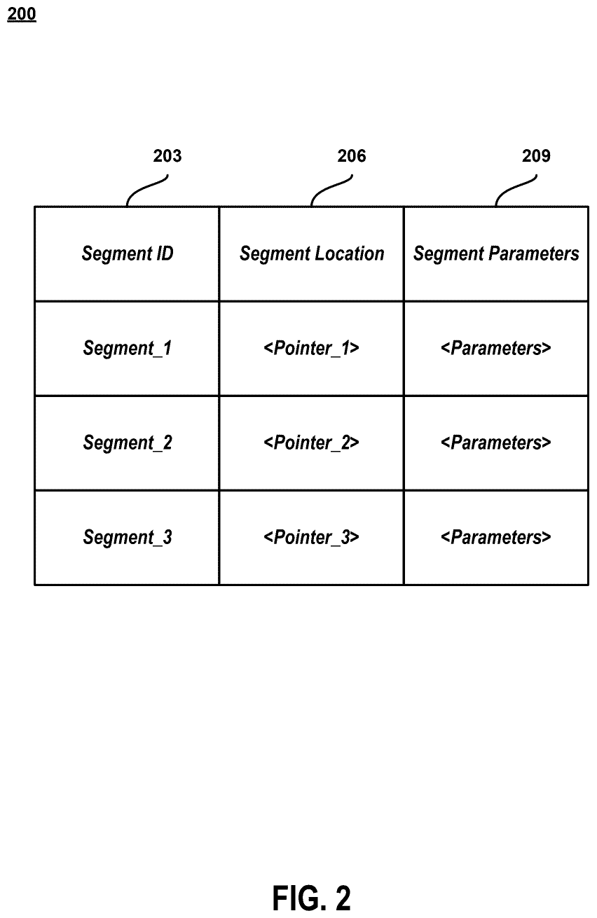

When machine learning subsystem 114 matches segments, machine learning subsystem 114 may store those matches. In particular, for each pair of a matching segment and the corresponding portion, machine learning subsystem 114 may generate an entry identifying each pair. Machine learning subsystem 114 may then discard one or more portions of the computer code within the computer code repository without a corresponding pair. That is, the machine learning subsystem 114 may store indications of computer code that has been updated at least once. The computer code that has not been updated may be discarded. However, when a new portion of computer code is identified, another segment may be added to the data structure (e.g., a data structure described in relation to FIG. 2).

FIG. 2 illustrates an excerpt of a data structure 200 for storing segment data. Data structure 200 may include fields for segment identifier 203, segment location 206, and segment parameters 209. Segment identifier 203 may be a string, a decimal, a hexadecimal, or another suitable identifier. For example, an identifier may be the name of a function. Segment location may point to a location of the code or another way the code may be retrieved. Segment parameters may be parameters associated with the segment such as input variables, output variables, and/or other suitable parameters. In some embodiments, machine learning subsystem 114 may write code parameters such as a number of variables (e.g., input and output variables) within the segment, a number of lines of code within the segment, commit parameters (e.g., how many times the code has been updated), and/or other suitable parameters.

In some embodiments, machine learning subsystem 114 may use a similarity model to identify a matching code segment. In particular, machine learning subsystem 114 may input each code segment of the plurality of segments and the updated computer code into a similarity model. The similarity model may determine a degree of similarity between two sets of textual data. For example, the similarity model may be a model that has been trained to determine a degree of similarity between two texts. Thus, machine learning subsystem 114 may receive an output from the similarity model indicating a similarity between the updated computer code and each code segment within the computer code repository. Machine learning subsystem 114 may then determine, based on output from the machine learning model, that a first code segment of the plurality of segments matches the updated computer code. For example, machine learning subsystem 114 may select the code segment that best matches the computer code update.

When a corresponding segment for the code update has been identified within the computer code repository, machine learning subsystem 114 may perform code comparisons between the new code segment and the current code segment within the repository. In particular, machine learning subsystem 114 may generate, based on the updated computer code, segment data. The segment data may include one or more code update parameters. Those parameters may include variable update parameters, commit parameters, or lines of code parameters. Variable updated parameters may indicate a number and type of variable changes. Commit parameters may indicate a number of commits or updates associated with the particular segment within the computer code repository, while the line code parameter indicates a number of lines, or a number of line changes associated with the segment.

In some embodiments, machine learning subsystem 114 may perform the following operations when generating the segment data. Machine learning subsystem 114 may determine a first number of variables within the updated computer code and a second number of variables within a matching code segment. For example, machine learning subsystem 114 may scan both the updated computer code and the matching code segment to identify a number of variables within both. For example, machine learning subsystem 114 may scan for input variables, output variables, and/or variables internal to the code segment and the updated computer code. Machine learning subsystem 114 may then generate a variable difference for the updated computer code. That is, machine learning subsystem 114 may identify a difference between the variables (e.g., a number indicating how many more/less variables are within the updated computer code and the matching segment).

Machine learning subsystem 114 may then determine a number of code updates associated with the updated computer code. For example, the matching segment may have been updated twenty times. In addition, machine learning subsystem 114 may determine a frequency of updates. For example, frequent updates may indicate sensitivity of the segment to updates. In some embodiments, machine learning subsystem 114 may determine how long ago the segment was updated, which may indicate how well the segment was designed. That is, if the segment was not updated for a long time, it has been designed well to handle its workload. Thus, machine learning subsystem 114 may generate a commit parameter based on the number of code updates and, in some cases, the frequency of updates.

Machine learning subsystem 114 may also determine a first set of line code parameters within the updated computer code and a second set of line code parameters within the matching code segment. For example, machine learning subsystem 114 may compare the number of lines of code within the updated computer code and the matching code segment and determine the difference in the number of lines. In some embodiments, machine learning subsystem 114 may determine a number of lines that have different content between the updated computer code and the matching code segment. For example, if the matching code segment has twenty lines and the updated computer code has twenty-two lines with five lines being different, machine learning subsystem 114 may determine a five-line difference in content and a two line difference in the number of lines. Machine learning subsystem 114 may then generate a line code parameter difference for the updated computer code. When all the parameters have been generated, machine learning subsystem 114 may add the variable difference, the commit parameter, and the line code parameter difference to the segment data.

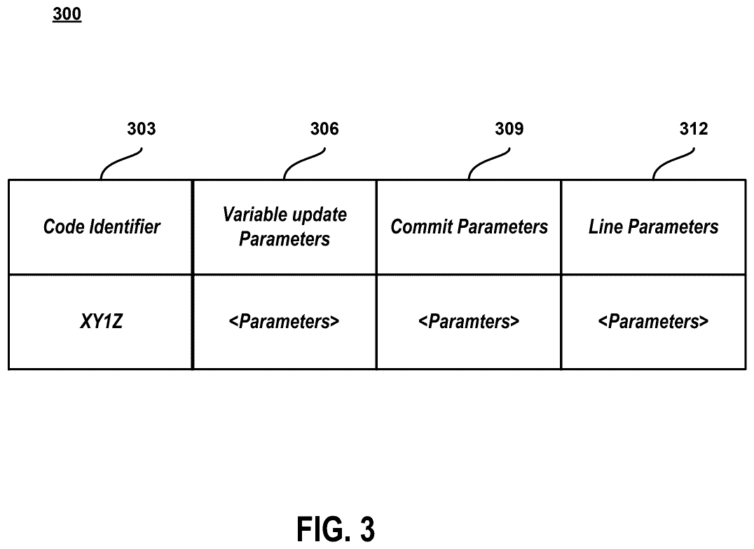

FIG. 3 illustrates an excerpt of a data structure 300 for storing update parameters. Field 303 may include a code identifier associated with the updated computer code. The code identifier may also be associated with the matching segment. Field 306 may store variable update parameters, with field 309 storing commit parameters and field 312 storing line parameters. In some embodiments, data structure 300 may include other fields.

Machine learning subsystem 114 may then input, into a machine learning model, the segment data to obtain a condition associated with the updated computer code. The machine learning model may be one that has been trained using time series data generated based on code updates to a plurality of portions of the computer code. Machine learning subsystem 114 may receive from the machine learning model a condition associated with the updated computer code. In some embodiments, the condition may include a determination of whether the updated computer code is predicted to cause one or more issues within the computer code repository. For example, the determination may indicate that other functions, code segments, procedures, and/or APIs may be broken if the updated computer code is deployed within the computer code repository.

Code analysis system 102 may use the following operations to train the machine learning model. Code analysis system 102 may use training subsystem 116 to train the machine learning model. Training subsystem 116 may include software components, hardware components, or a combination of both. For example, machine learning subsystem 114 may include software components (e.g., API calls) that train one or more machine learning models. Training subsystem 116 may access various data, for example, in memory. In particular, training subsystem 116 may receive computer code update data. The computer code update data may include a plurality of computer code segments that were used as updates to the computer code repository over a period of time. For example, the computer code update data may include code updates and/or segment update data (e.g., variable parameters, commit parameters, and/or line parameters).

Training subsystem 116 may split the computer code within the computer code repository into the plurality of portions based on the plurality of computer code segments within the computer code update data. Each portion of the plurality of portions may correspond to a given segment of the plurality of computer code segments.

Training subsystem 116 may use the following operations to split the computer code. Training subsystem 116 may compare, for each computer code segment within the computer code update data, heading data with stored heading data associated with the computer code within the computer code repository. For example, the heading data for a function, a procedure, or an API may be the name, any input variables, and/or any output variables. Accordingly, training subsystem 116 may compare the headings of each segment within the computer code repository with the headings of any updates that were executed to the computer code segments. Training subsystem 116 may then match a first code segment with a first portion of the computer code within the computer code repository based on the heading data matching the stored heading data. That is, if heading data matches between an update that was executed and a segment within the computer code repository, training subsystem 116 may find a match. Training subsystem 116 may split the computer code within the computer code repository based on the matching.

In some embodiments, when the code is split, training subsystem 116 may generate a code map for the computer code repository with the first portion of the computer code having an entry within the code map. That is, the map may include names of code segments and corresponding pointers to code locations with parameter data as described above. This data may be stored in a database table or a code file that may then be input into the machine learning model.

When the splitting is completed, training subsystem 116 may determine, for each portion of the plurality of portions based on a corresponding segment, corresponding segment data. Each segment data may include the one or more code update parameters, the one or more code update parameters comprising variable update parameters, commit parameters, or lines of code parameters. In some embodiments, training subsystem 116 may generate those parameters on the fly when two segments match or those parameters may be predetermined and stored with the updated code segment. Training subsystem 116 may then generate, for the plurality of portions, a time series dataset that includes combined segment data arranged chronologically. Arranging the data chronologically, for example, with a timestamp may allow the machine learning model to be trained to determine the quality associated with a particular update. For example, if the time between two updates is short, an update may not be of a good quality. However, if the time between two updates is long, the update may be of a high quality due to not requiring changes for a longer time.

Training subsystem 116 may then train the machine learning model using the time series dataset and the plurality of portions of code to output a condition associated with a candidate code portion when the candidate code portion is input into the machine learning model. For example, training subsystem 116 may input the time series dataset into the training routine of the machine learning model to train the machine learning model.

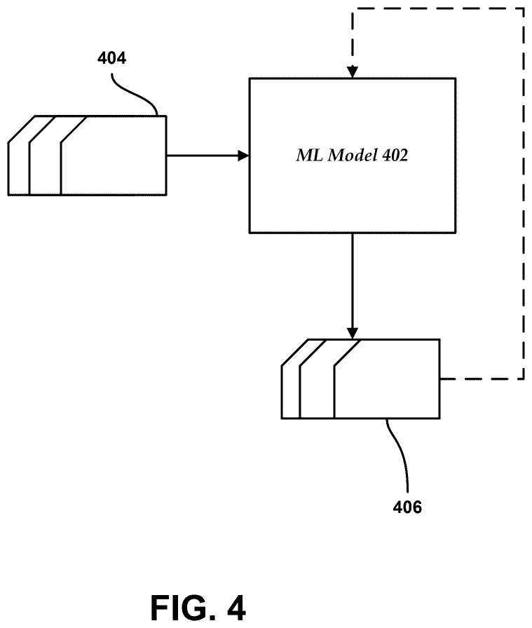

FIG. 4 illustrates an exemplary machine learning model. The machine learning model may have been trained using the time series dataset and the plurality of portions of code to output a condition associated with a candidate code portion when the candidate code portion is input into the machine learning model. Machine learning model 402 may take input 404 (e.g., time series data) and may output a condition 406 associated with the candidate code portion. The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Once the machine learning model is trained, it may output predictions that may include conditions associated with the updated computer code. Thus, code analysis system 102 may, based on the condition received from the machine learning model, generate for display one or more action identifiers for a user to perform. In some embodiments, code analysis system 102 may perform the following actions to output the one or more action identifiers. Code analysis system 102 may compare the condition received from the machine learning model (e.g., the predicted condition) with a plurality of predetermined conditions. For example, code analysis system 102 may access a plurality of predetermined conditions that may have associated actions recommending how to fix the condition.

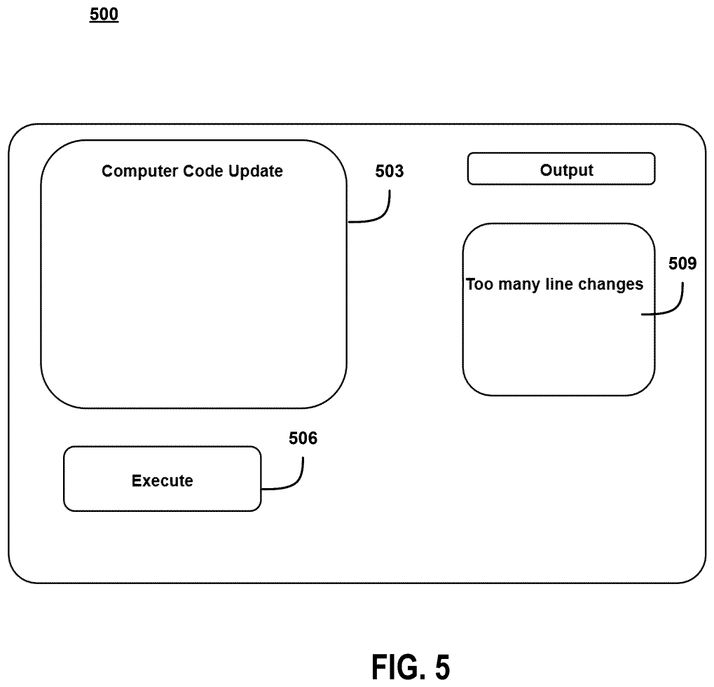

Code analysis system 102 may then retrieve a plurality of functions associated with the plurality of predetermined conditions. Those functions may instruct an operator how to fix the problem or issue with the computer code update. Code analysis system 102 may then generate for display a plurality of selectable function identifiers. FIG. 5 illustrates an example interface 500 for displaying any issues with a computer code update. Area 503 may include the computer code itself, while button 506 executes the mechanism for identifying any issues with the updated computer code. Area 509 displays any issues and in some cases may display any variables that were found.

In some embodiments, the machine learning model may be a self-supervised learning (SSL) model. For example, the machine learning model trained using SSL may train itself by using one part of the input to generate another part of the input. In some embodiments, SSL may include using input to generate labels for the input data, thereby saving a large amount of time as label generating is a labor-intensive process. That is, the supervised task is modified into an unsupervised task. In some embodiments, the training routine of an SSL Model may take, as input, unlabeled and/or unstructured data, and may first output labelled/structured data to use as input into the rest of the training routine.

### Computing Environment

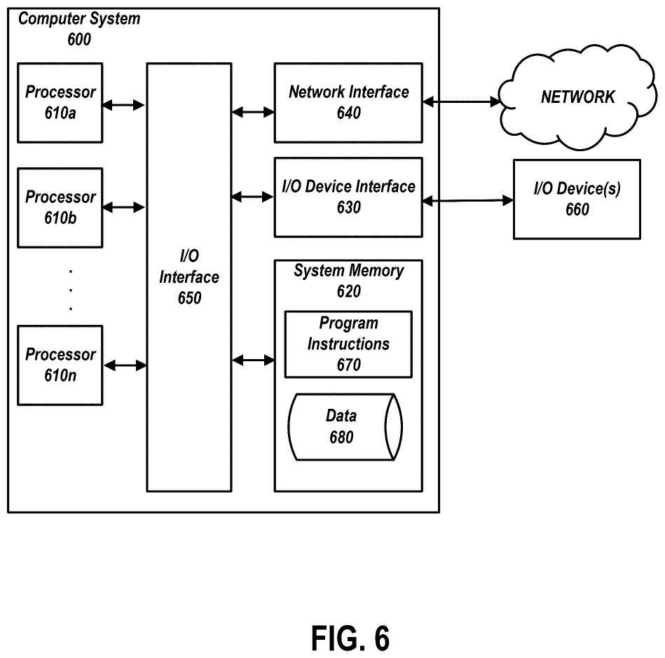

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multiprocessor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. Non-transitory, computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or it may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Operation Flow

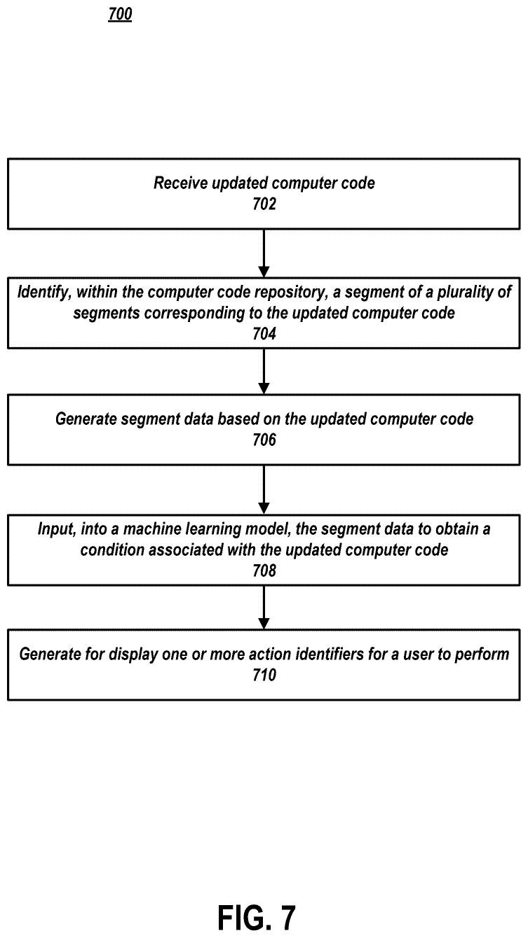

FIG. 7 is a flow chart of process 700 for executing an artificial intelligence model that predicts issues with updated computer code. The operations of FIG. 7 may use components described in relation to FIG. 6. In some embodiments, code analysis system 102 may include one or more components of computer system 600. At 702, code analysis system 102 receives updated computer code. For example, code analysis system 102 may receive the updated computer code from data node 104 or from one of client devices 108a-108n. Code analysis system 102 may receive the updated computer code over network 150 using network interface 640.

At 704, code analysis system 102 identifies, within the computer code repository, a segment of a plurality of segments corresponding to the updated computer code. Code analysis system 102 may use one or more processors 610a, 610b, and/or 610n to perform this operation. At 706, code analysis system 102 generates segment data based on the updated computer code. For example, code analysis system 102 may use one or more processors 610a-610n to perform the operation and store the results in system memory 620.

At 708, code analysis system 102 inputs, into a machine learning model, the segment data to obtain a condition associated with the updated computer code. Code analysis system 102 may use one or more processors 610a, 610b, and/or 610n to perform this operation. At 710, code analysis system 102 generates for display one or more action identifiers for a user to perform. For example, code analysis system 102 may use one or more processors 610a-610n to perform the operation and store the results in system memory 620.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: receiving updated computer code, wherein the updated computer code comprises a computer code update to computer code within a computer code repository; identifying, within the computer code repository, a segment of a plurality of segments corresponding to the updated computer code, wherein the computer code within the computer code repository has been split into the plurality of segments based on a plurality of computer code portions that have been updated during a predetermined time period; generating, based on the updated computer code, segment data, wherein the segment data comprises one or more code update parameters; inputting, into a machine learning model, the segment data to obtain a condition associated with the updated computer code, wherein the machine learning model has been trained using time series data generated based on code updates to a plurality of portions of the computer code; and based on the condition received from the machine learning model, generating for display one or more action identifiers for a user to perform.

2. Any of the preceding embodiments, wherein the one or more code update parameters comprise variable update parameters, commit parameters, or lines of code parameters.

3. Any of the preceding embodiments, wherein identifying, within the computer code repository, the segment of the plurality of segments corresponding to the updated computer code comprises: comparing execution commands for each code segment of the plurality of segments with corresponding execution commands for the updated computer code; and determining, based on comparing, that a first code segment of the plurality of segments matches the updated computer code.

4. Any of the preceding embodiments, wherein identifying, within the computer code repository, the segment of the plurality of segments corresponding to the updated computer code comprises: inputting each code segment of the plurality of segments and the updated computer code into a similarity model, wherein the similarity model determines a degree of similarity between two sets of textual data; and determining, based on output from the machine learning model, that a first code segment of the plurality of segments matches the updated computer code.

5. Any of the preceding embodiments, wherein generating the segment data comprises: determining a first number of variables within the updated computer code and a second number of variables within a matching code segment; generating a variable difference for the updated computer code; determining a number of code updates associated with the updated computer code; generating a commit parameter based on the number of code updates; determining a first set of line code parameters within the updated computer code and a second set of line code parameters within the matching code segment; generating a line code parameter difference for the updated computer code; and adding the variable difference, the commit parameter, and the line code parameter difference to the segment data.

6. Any of the proceeding embodiments, wherein generating for display the one or more action identifiers for the user to perform comprises: comparing the condition with a plurality of predetermined conditions; retrieving a plurality of functions associated with the plurality of predetermined conditions; and generating for display a plurality of selectable function identifiers.

7. Any of the preceding embodiments, wherein training the machine learning model using the time series data comprises: receiving computer code update data, wherein the computer code update data comprises a plurality of computer code segments that were used as updates to the computer code repository over a period of time; splitting the computer code within the computer code repository into the plurality of portions based on the plurality of computer code segments within the computer code update data, wherein each portion of the plurality of portions corresponds to a given segment of the plurality of computer code segments; determining, for each portion of the plurality of portions based on a corresponding segment, corresponding segment data, wherein each segment data comprises the one or more code update parameters, the one or more code update parameters comprising variable update parameters, commit parameters, or lines of code parameters; and generating, for the plurality of portions, a time series dataset comprising combined segment data arranged chronologically.

8. Any of the preceding embodiments, wherein splitting the computer code within the computer code repository into the plurality of portions based on the plurality of computer code segments within the computer code update data comprises: comparing, for each computer code segment within the computer code update data, header data with stored heading data associated with the computer code within the computer code repository; and matching a first code segment with a first portion of the computer code within the computer code repository based on the heading data matching the stored heading data.

9. Any of the preceding embodiments, further comprising: generating a code map for the computer code repository with the first portion of the computer code having an entry within the code map.

10. Any of the preceding embodiments, wherein splitting the computer code within the computer code repository into the plurality of portions comprises: identifying, for each segment of a plurality of computer code segments, a corresponding portion within the computer code repository; for each pair of a matching segment and the corresponding portion, generating an entry identifying each pair; and discarding one or more portions of the computer code within the computer code repository without a corresponding pair.

11. Any of the preceding embodiments, wherein the condition comprises a determination of whether the updated computer code is predicted to cause one or more issues within the computer code repository.

12. A tangible, non-transitory, machine-readable medium storing instructions that, when executed by a data processing apparatus, cause the data processing apparatus to perform operations comprising those of any of embodiments 1-11.

13. A system comprising: one or more processors; and memory storing instructions that, when executed by the processors, cause the processors to effectuate operations comprising those of any of embodiments 1-11.

14. A system comprising means for performing any of embodiments 1-11.

15. A system comprising cloud-based circuitry for performing any of embodiments 1-11.

What is claimed is:

1. A system for building an artificial intelligence model that predicts computer code, the system comprising:
one or more processors; and
a non-transitory, computer-readable storage medium storing instructions, which when executed by the one or more processors cause the one or more processors to:
receive computer code update data, wherein the computer code update data comprises a plurality of computer code segments that were used as updates to a computer code repository over a period of time;
split the computer code within the computer code repository into a plurality of portions based on the plurality of computer code segments within the computer code update data, wherein each portion of the plurality of portions corresponds to a segment of the plurality of computer code segments;
determine, for each portion of the plurality of portions based on a corresponding segment, corresponding segment data, wherein each segment data comprises one or more code update parameters, the one or more code update parameters comprising variable update parameters, commit parameters, or lines of code parameters;
generate, for the plurality of portions, a time series dataset comprising combined segment data arranged chronologically; and
train a machine learning model using the time series dataset and the plurality of portions of code to output a condition associated with a candidate code portion when the candidate code portion is input into the machine learning model.

2. A method comprising:
receiving updated computer code, wherein the updated computer code comprises a computer code update to computer code within a computer code repository;
identifying, within the computer code repository, a segment of a plurality of segments corresponding to the updated computer code, wherein the computer code within the computer code repository has been split into the plurality of segments based on a plurality of computer code portions that have been updated during a predetermined time period;
generating, based on the updated computer code, segment data, wherein the segment data comprises one or more code update parameters;
inputting, into a machine learning model, the segment data to obtain a condition associated with the updated computer code, wherein the machine learning model has been trained using time series data generated based on code updates to a plurality of portions of the computer code; and
based on the condition received from the machine learning model, generating for display one or more action identifiers for a user to perform.

3. The method of claim 2, wherein the one or more code update parameters comprise variable update parameters, commit parameters, or lines of code parameters.

4. The method of claim 2, wherein identifying, within the computer code repository, the segment of the plurality of segments corresponding to the updated computer code comprises:
comparing execution commands for each code segment of the plurality of segments with corresponding execution commands for the updated computer code; and
determining, based on comparing, that a first code segment of the plurality of segments matches the updated computer code.

5. The method of claim 2, wherein identifying, within the computer code repository, the segment of the plurality of segments corresponding to the updated computer code comprises:
inputting each code segment of the plurality of segments and the updated computer code into a similarity model, wherein the similarity model determines a degree of similarity between two sets of textual data; and
determining, based on output from the machine learning model, that a first code segment of the plurality of segments matches the updated computer code.

6. The method of claim 2, wherein generating the segment data comprises:
determining a first number of variables within the updated computer code and a second number of variables within a matching code segment;
generating a variable difference for the updated computer code;
determining a number of code updates associated with the updated computer code;
generating a commit parameter based on the number of code updates;
determining a first set of line code parameters within the updated computer code and a second set of line code parameters within the matching code segment;
generating a line code parameter difference for the updated computer code; and
adding the variable difference, the commit parameter, and the line code parameter difference to the segment data.

7. The method of claim 2, wherein generating for display the one or more action identifiers for the user to perform comprises:
comparing the condition with a plurality of predetermined conditions;
retrieving a plurality of functions associated with the plurality of predetermined conditions; and
generating for display a plurality of selectable function identifiers.

8. The method of claim 2, wherein training the machine learning model using the time series data comprises:
receiving computer code update data, wherein the computer code update data comprises a plurality of computer code segments that were used as updates to the computer code repository over a period of time;
splitting the computer code within the computer code repository into the plurality of portions based on the plurality of computer code segments within the computer code update data, wherein each portion of the plurality of portions corresponds to a given segment of the plurality of computer code segments;
determining, for each portion of the plurality of portions based on a corresponding segment, corresponding segment data, wherein each segment data comprises the one or more code update parameters, the one or more code update parameters comprising variable update parameters, commit parameters, or lines of code parameters; and
generating, for the plurality of portions, a time series dataset comprising combined segment data arranged chronologically.

9. The method of claim 8, wherein splitting the computer code within the computer code repository into the plurality of portions based on the plurality of computer code segments within the computer code update data comprises:
comparing, for each computer code segment within the computer code update data, header data with stored heading data associated with the computer code within the computer code repository; and
matching a first code segment with a first portion of the computer code within the computer code repository based on the heading data matching the stored heading data.

10. The method of claim 9, further comprising:
generating a code map for the computer code repository with the first portion of the computer code having an entry within the code map.

11. The method of claim 2, wherein splitting the computer code within the computer code repository into the plurality of portions comprises:
identifying, for each segment of a plurality of computer code segments, a corresponding portion within the computer code repository;
for each pair of a matching segment and the corresponding portion, generating an entry identifying each pair; and
discarding one or more portions of the computer code within the computer code repository without a corresponding pair.

12. The method of claim 2, wherein the condition comprises a determination of whether the updated computer code is predicted to cause one or more issues within the computer code repository.

13. One or more non-transitory, computer-readable storage media storing instructions that when executed by one or more processors cause operations comprising:
receiving updated computer code, wherein the updated computer code comprises a computer code update to computer code within a computer code repository;
identifying, within the computer code repository, a segment of a plurality of segments corresponding to the updated computer code, wherein the computer code within the computer code repository has been split into the plurality of segments based on a plurality of computer code portions that have been updated during a predetermined time period;
generating, based on the updated computer code, segment data, wherein the segment data comprises one or more code update parameters;
inputting, into a machine learning model, the segment data to obtain a condition associated with the updated computer code, wherein the machine learning model has been trained using time series data generated based on code updates to a plurality of portions of the computer code; and
based on the condition received from the machine learning model, generating for display one or more action identifiers for a user to perform.

14. The one or more non-transitory, computer-readable storage media of claim 13, wherein the one or more code update parameters comprise variable update parameters, commit parameters, or lines of code parameters.

15. The one or more non-transitory, computer-readable storage media of claim 14, wherein the instructions for identifying, within the computer code repository, the segment of the plurality of segments corresponding to the updated computer code further cause the one or more processors to perform operations comprising:
comparing execution commands for each code segment of the plurality of segments with corresponding execution commands for the updated computer code; and
determining, based on comparing, that a first code segment of the plurality of segments matches the updated computer code.

16. The one or more non-transitory, computer-readable storage media of claim 13, wherein the instructions for identifying, within the computer code repository, the segment of the plurality of segments corresponding to the updated computer code further cause the one or more processors to perform operations comprising:
inputting each code segment of the plurality of segments and the updated computer code into a similarity model, wherein the similarity model determines a degree of similarity between two sets of textual data; and
determining, based on output from the machine learning model, that a first code segment of the plurality of segments matches the updated computer code.

17. The one or more non-transitory, computer-readable storage media of claim 16, wherein the instructions for generating the segment data further cause the one or more processors to perform operations comprising:
determining a first number of variables within the updated computer code and a second number of variables within a matching code segment;
generating a variable difference for the updated computer code;
determining a number of code updates associated with the updated computer code;
generating a commit parameter based on the number of code updates;
determining a first set of line code parameters within the updated computer code and a second set of line code parameters within the matching code segment;
generating a line code parameter difference for the updated computer code; and
adding the variable difference, the commit parameter, and the line code parameter difference to the segment data.

18. The one or more non-transitory, computer-readable storage media of claim 13, wherein the instructions for generating for display the one or more action identifiers for the user to perform further cause the one or more processors to perform operations comprising:
comparing the condition with a plurality of predetermined conditions;
retrieving a plurality of functions associated with the plurality of predetermined conditions; and
generating for display a plurality of selectable function identifiers.

19. The one or more non-transitory, computer-readable storage media of claim 13, wherein the instructions for splitting the computer code within the computer code repository into the plurality of portions further cause the one or more processors to perform operations comprising:
identifying, for each segment of a plurality of computer code segments, a corresponding portion within the computer code repository;
for each pair of a matching segment and the corresponding portion, generating an entry identifying each pair; and
discarding one or more portions of the computer code within the computer code repository without a corresponding pair.

20. The one or more non-transitory, computer-readable storage media of claim 13, wherein the condition comprises a determination of whether the updated computer code is predicted to cause one or more issues within the computer code repository.
